(19) United States
(12) Patent Application Publication
(10) Pub. No.: US 2020/0211386 A1
(43) Pub. Date: Jul. 2, 2020

(54) VEHICLE COMMUNICATION SYSTEM, VEHICLE-MOUNTED LIGHT EMITTING DEVICE, INFORMATION ACQUIRING AND PROVIDING DEVICE, AND VEHICLE-MOUNTED DEVICE

(71) Applicant: TOYODA GOSEI CO., LTD., Kiyosu-shi (JP)

(72) Inventors: Kazuhisa TAKAHASHI, Kiyosu-shi (JP); Takeshi KONDO, Kiyosu-shi (JP); Bunpei MORITA, Kiyosu-shi (JP); Tasuku ISHIHARA, Kiyosu-shi (JP)

(21) Appl. No.: 16/701,646

(22) Filed: Dec. 3, 2019

(30) Foreign Application Priority Data
Dec. 27, 2018 (JP) 2018-246065

(51) Int. Cl. G08G 1/0967; G08G 1/01; G08G 1/16; H04B 10/116

(52) U.S. Cl. CPC G08G 1/0967; H04B 10/116; G08G 1/161; G08G 1/0112

(57) ABSTRACT

A vehicle communication system includes a vehicle-mounted light emitting device including a vehicle body configured to emit visible light or a molding attached to the vehicle body and configured to emit visible light and a light emission controller being configured to cause the vehicle body or the molding to flicker at a frequency equal to or higher than a predetermined frequency such that traffic information is visually recognized by a person in the vicinity of a host vehicle and is transmitted to the vicinity of the host vehicle through optical wireless communication. In addition, the vehicle communication system includes an information acquiring and providing device including a receiver configured to receive the traffic information transmitted from the vehicle body or the molding through the optical wireless communication and a provider configured to provide the traffic information received by the receiver to a person.

### INCORPORATION BY REFERENCE

The disclosure of Japanese Patent Application No. 2018-246065 filed on Dec. 27, 2018 including the specification, drawings and abstract is incorporated herein by reference in its entirety.

### BACKGROUND

### 1. Technical Field

The disclosure relates to a vehicle communication system, a vehicle-mounted light emitting device, an information acquiring and providing device, and a vehicle-mounted device.

### 2. Description of Related Art

Japanese Unexamined Patent Application Publication No. 2004-326705 (JP 2004-326705 A) discloses a vehicle communication system for vehicle-to-vehicle communication. The vehicle communication system is provided with a light emitting unit and a receiver. The light emitting unit is an LED such as a head lamp, a brake lamp, and an auxiliary lamp of a vehicle. The receiver is a back-eye camera that images a rear field of vision of the vehicle or a camera for visual assistance that images a lateral field of vision of the vehicle. The vehicle communication system communicates information to another vehicle by superimposing a signal that is obtained by modulating vehicle identification information or a message into a predetermined modulation code on light emitted from the light emitting unit. In a case where a signal from a non-host vehicle is received by the receiver of the vehicle, the vehicle communication system transmits voice data or text data obtained through demodulation of the signal to an occupant of the vehicle by causing a speaker to output the voice data or the text data or causing a display panel to display the voice data or the text data. Accordingly, vehicle-to-vehicle communication can be realized when the light emitting unit and the receiver as described above is installed in each of a large number of vehicles.

### SUMMARY

The above-described vehicle communication system is only for vehicle-to-vehicle communication performed by means of a light emitting unit such as a head lamp of a vehicle and a receiver such as a camera. However, on an assumption that an autonomous vehicle that can be autonomously driven will appear on a road in the future, transmission of information for communication and the like between the autonomous vehicle and the driver of a manually driven vehicle or transmission of information between the autonomous vehicle and a pedestrian matters as well as transmission of information between vehicles including the autonomous vehicle. Therefore, in the case of a system that performs communication between vehicles only like the above-described vehicle communication system, there is a possibility that transmission of information from a vehicle is insufficient.

The disclosure provides a vehicle communication system, a vehicle-mounted light emitting device, an information acquiring and providing device, and a vehicle-mounted device with which it is possible to easily and reliably perform transmission of traffic information from a vehicle.

A first aspect of the disclosure relates to a vehicle communication system. The vehicle communication system includes a vehicle-mounted light emitting device and an information acquiring and providing device. The vehicle-mounted light emitting device includes a vehicle body or a molding and a light emission controller. The vehicle body or the molding is configured to emit visible light. The molding is attached to the vehicle body. The light emission controller is configured to cause the vehicle body or the molding to flicker at a frequency equal to or higher than a predetermined frequency such that traffic information is visually recognized by a person in the vicinity of a host vehicle and is transmitted to the vicinity of the host vehicle through optical wireless communication. The information acquiring and providing device includes a receiver and a provider. The receiver is configured to receive the traffic information transmitted from the vehicle body or the molding through the optical wireless communication. The provider is configured to provide the traffic information received by the receiver to a person who uses the information acquiring and providing device.

A second aspect of the disclosure relates to the vehicle-mounted light emitting device. A third aspect of the disclosure relates to the information acquiring and providing device.

A fourth aspect of the disclosure relates to a vehicle-mounted device that includes the vehicle body or the molding, the light emission controller, the receiver, and the provider.

In the case of the above-described configuration, the vehicle body or the molding of the vehicle flickers at the frequency equal to or higher than the predetermined frequency such that the traffic information is visually recognized by the person in the vicinity of the host vehicle and is transmitted to the vicinity of the host vehicle through optical wireless communication. In this case, the person in the vicinity of the vehicle can recognize the traffic information by visually recognizing light emitted and displayed by the vehicle body or the molding. In addition, the provider of the information acquiring and providing device provides the traffic information that is transmitted from the vehicle body or the molding of the vehicle through the optical wireless communication and is received by the receiver to the person. In this case, the person who uses the information acquiring and providing device can recognize the traffic information through the output of the provider. Accordingly, it is possible to easily and reliably perform transmission of traffic information from a vehicle-mounted light emitting device of a vehicle to a user of an information acquiring and providing device in the vicinity of the vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a configuration diagram of a vehicle communication system according to an embodiment;

FIG. 2 is a diagram schematically illustrating a situation where a non-host vehicle in which an information acquiring and providing device is installed follows a vehicle constituting the vehicle communication system according to the embodiment;

FIG. 3 is a diagram schematically illustrating a situation where a pedestrian is present at an intersection with poor visibility through which the vehicle constituting the vehicle communication system according to the embodiment passes and the non-host vehicle in which the information acquiring and providing device is installed follows the vehicle;

FIG. 4 is a diagram schematically illustrating a situation where the non-host vehicle in which the information acquiring and providing device is installed follows the vehicle constituting the vehicle communication system according to the embodiment with congestion on a road detected by the vehicle;

FIG. 5 is a diagram schematically illustrating a situation where traffic information transmitted by means of light emitted and displayed by a vehicle body or a molding of the vehicle constituting the vehicle communication system according to the embodiment is output from a provider after being received by the following non-host vehicle in which the information acquiring and providing device is installed;

FIG. 6 is a diagram schematically illustrating a situation where the vehicle constituting the vehicle communication system according to the embodiment passes through an intersection at which a pedestrian having the information acquiring and providing device is about to cross a pedestrian crossing;

FIG. 7 is a diagram schematically illustrating a situation where traffic information transmitted by means of light emitted and displayed by the vehicle body or the molding of the vehicle constituting the vehicle communication system according to the embodiment is provided after being received by the information acquiring and providing device used by the pedestrian; and

FIG. 8 is a flowchart of a sequence of operations performed between a vehicle-mounted light emitting device and the information acquiring and providing device in the vehicle communication system according to the embodiment.

### DETAILED DESCRIPTION OF EMBODIMENTS

Hereinafter, specific embodiments of a vehicle communication system, a vehicle-mounted light emitting device, an information acquiring and providing device, and a vehicle-mounted device according to the disclosure will be described by using drawings.

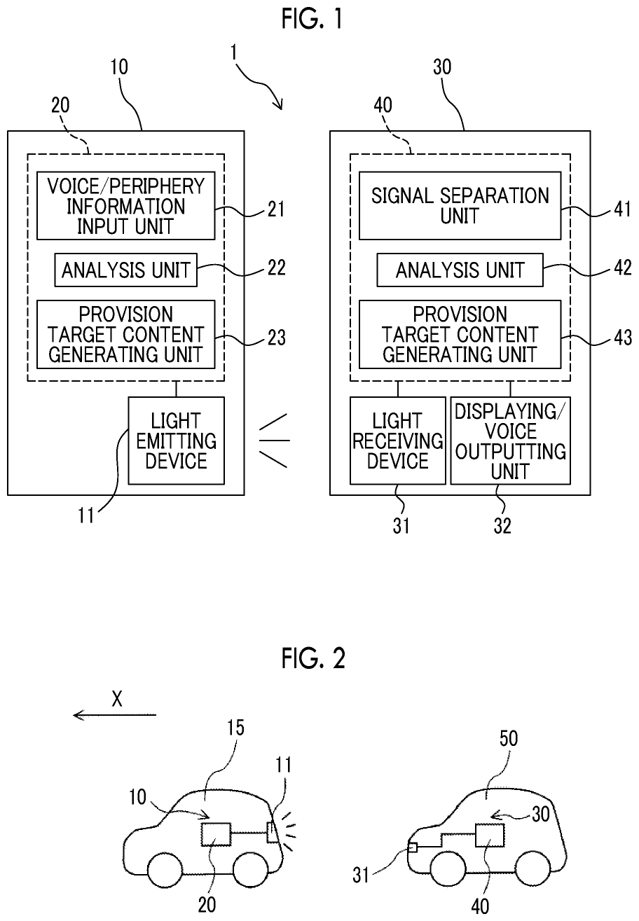

A vehicle communication system 1 in an embodiment is a system that receives information between vehicles, between a vehicle and a pedestrian, or between a vehicle and a bicycle or a two-wheeled vehicle. As shown in FIG. 1, the vehicle communication system 1 is provided with a vehicle-mounted light emitting device 10 and an information acquiring and providing device 30.

The vehicle-mounted light emitting device 10 is installed in a host vehicle 15. The host vehicle 15 is an autonomous vehicle that is autonomously driven without being driven by a driver. The information acquiring and providing device 30 is installed in a vehicle, a two-wheeled vehicle, or a bicycle or a portable device such as a smartphone or a wearable terminal carried by a person such as a pedestrian. Examples of a vehicle in which the information acquiring and providing device 30 is installed may include the host vehicle 15 and may include a vehicle different from the host vehicle 15. Examples of the wearable terminal include a glasses-shaped device, an in-protective equipment device attachable to a hat or a helmet, an in-accessary device such as a necklace or an earring.

The vehicle-mounted light emitting device 10 is a device that uses an outer surface of the host vehicle 15 as a display panel. The vehicle-mounted light emitting device 10 includes light emitting devices 11 that constitute display panels. The light emitting devices 11 emit light on the outer surface of the host vehicle 15. The light emitting devices 11 are LEDs or the like. A plurality of the light emitting devices 11 is provided. Light emitted by the light emitting devices 11 includes visible light. The light emitting devices 11 include a light source that generates visible light.

The light emitting devices 11 are fixed to a vehicle body 12 of the host vehicle 15 or fixed to moldings 13 attached to the vehicle body 12. For example, the light emitting devices 11 may be buried in the vehicle body 12 or the moldings 13. In addition, the light emitting device 11 may be provided in each of a plurality of positions in the vehicle body 12 and may be provided in each of a plurality of the moldings 13. Light from the light emitting devices 11 is emitted to the vicinity of the host vehicle 15 through the vehicle body 12 or the moldings 13. That is, the vehicle body 12 or the moldings 13 can emit visible light by means of the light emitting devices 11.

Note that, in a case where light is emitted by the vehicle body 12, portions of the vehicle body 12 in which the light emitting devices 11 are disposed are a front surface, a rear surface, side surfaces, or a bonnet of the host vehicle 15. The moldings 13 include a plated glossy component and are a back door molding, a side molding, a front molding, an emblem, and the like. In a case where light is emitted from the moldings 13, the moldings 13 include display areas that can be visually recognized as display panels by a person in the vicinity of the host vehicle 15. The vehicle body 12 or the moldings 13 displays a specific color, a specific text, a specific image, or the like while emitting light by means of the light emitting devices 11.

The vehicle-mounted light emitting device 10 includes a communication electronic control unit (hereinafter, will be referred to as vehicle side communication ECU) 20 that is composed of a microcomputer serving as a main component. The vehicle side communication ECU 20 is electrically connected to the light emitting devices 11. The vehicle side communication ECU 20 is an example of a light emission controller that controls light emitted and displayed by the vehicle body 12 or the moldings 13, that is, light emission of the light emitting devices 11. The vehicle side communication ECU 20 includes a voice/surrounding information input unit 21, an analysis unit 22, a provision target content generating unit 23.

The voice/surrounding information input unit 21 is a unit into which a voice output by an occupant such as the driver of the host vehicle 15 is input through a microphone and information about the vicinity of the host vehicle 15 is input through a camera, a sensor, a navigation device, or the like. Examples of the voice output by the occupant include a voice that is output when the occupant requests the host vehicle 15 to be stopped or to start to move in a case where the host vehicle 15 is an autonomous vehicle and a voice that is output when the occupant requests a blinker or a hazard lamp to flicker. In addition, examples of the information about the vicinity of the host vehicle 15 include a captured image of the vicinity of the host vehicle 15 which is captured by a camera, information on whether there is an object (such as vehicle or person) relatively approaching the host vehicle 15 which is obtained by a proximity sensor, a sonar sensor, a millimeter wave sensor, a radar sensor, or the like, and information about an intersection where visibility is poor.

The analysis unit 22 is a unit that detects the current state of the host vehicle 15 or a state that the host vehicle 15 is presumed to enter as traffic information based on information including a voice input to the voice/surrounding information input unit 21 and analyzes the traffic information. Note that, a relationship between information input to the voice/surrounding information input unit 21 and traffic information may be stored in a predetermined storage unit in advance.

For example, when the host vehicle 15 is in an autonomously driven state, the analysis unit 22 detects the autonomously driven state as operation information of the host vehicle 15. The host vehicle 15 detects an intersection where visibility is poor as intersection information, detects a pedestrian crossing in the vicinity of the intersection when the host vehicle 15 passes through the intersection as pedestrian information, and determines whether the pedestrian is about to cross the intersection or not. When the host vehicle 15 as a preceding vehicle detects the approach of a following non-host vehicle, a fact that the host vehicle 15 is in a risky state is detected as risk information. When the host vehicle 15 approaches a preceding vehicle and is stopped on a road that is not an intersection or when the host vehicle 15 enters a congested road based on received VICS (registered trademark) information, a fact that a road on which the host vehicle 15 travels is congested is detected congestion information.

The provision target content generating unit 23 is a unit that generates content to be transmitted and provided to a non-host vehicle or another person such as an occupant of the non-host vehicle and a pedestrian based on a state detected and analyzed by the analysis unit 22. Note that, a relationship between traffic information detected by the analysis unit 22 and provision target content may be stored in a predetermined storage unit in advance.

For example, when the host vehicle 15 travels in an autonomously driven state in a proceeding direction X as shown in FIG. 2, the provision target content generating unit 23 causes the vehicle body 12 or the moldings 13 to emit and display light to show the other person (for example, following non-host vehicle 50 or occupant of non-host vehicle 50) in the vicinity of the host vehicle 15 that the host vehicle 15 is in the autonomously driven state as traffic information. In addition, when the host vehicle 15 does not travel in an autonomously driven state although the host vehicle 15 is an autonomous vehicle, the vehicle body 12 or the moldings 13 is caused to emit and display light to show the other person in the vicinity of the host vehicle 15 that the host vehicle 15 is in a non-autonomously driven state as traffic information.

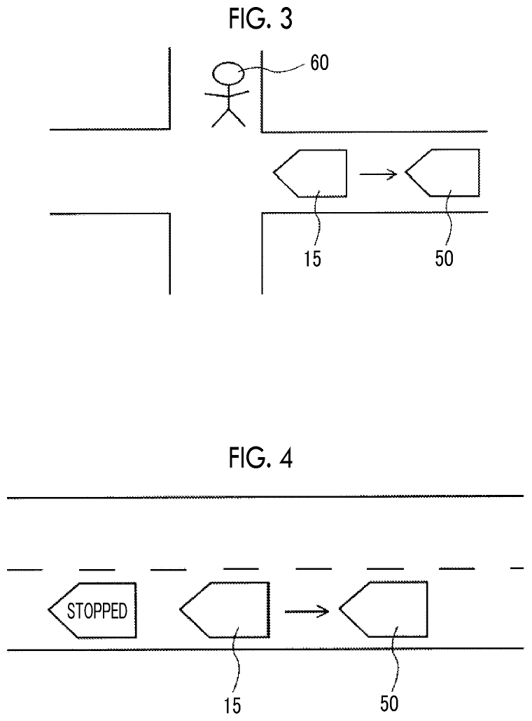

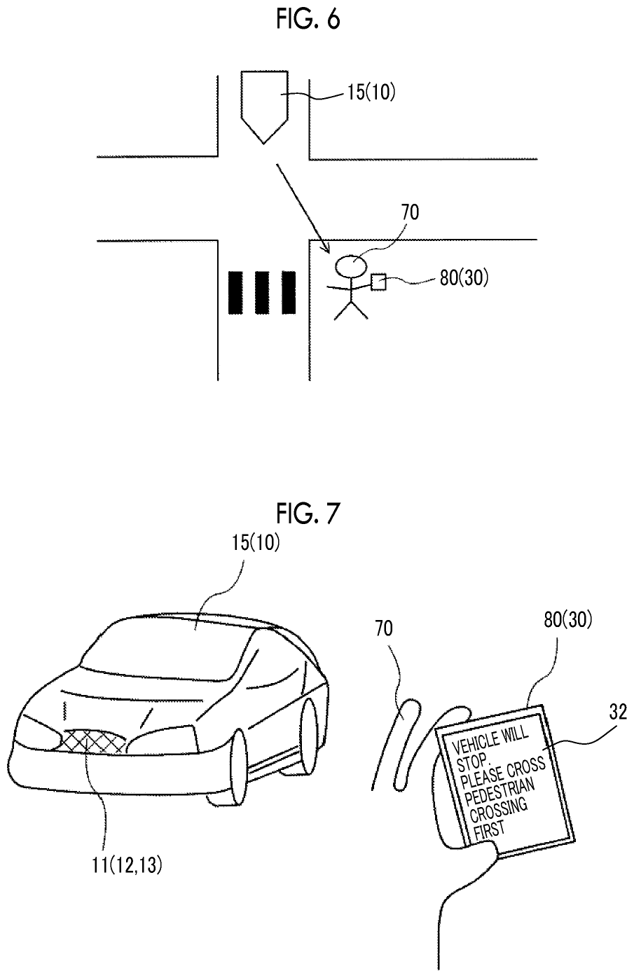

In addition, for example, when the host vehicle 15 detects a pedestrian 60 at an intersection where visibility is poor and a non-host vehicle 50 following the host vehicle 15 is present as shown in FIG. 3, the provision target content generating unit 23 causes the vehicle body 12 or the moldings 13 to emit and display light to show operation information or operation announcement information indicating that the host vehicle 15 will stop in front of the intersection at which the pedestrian 60 is present to the following non-host vehicle 50 as traffic information. When the host vehicle 15 detects congestion on a road as shown in FIG. 4, the vehicle body 12 or the moldings 13 is caused to emit and display light to notify the following non-host vehicle 50 of congestion information as traffic information. When the host vehicle 15 detects a pedestrian 70 at an intersection and detects that the pedestrian 70 is about to cross a pedestrian crossing or the intersection as shown in FIG. 6, the vehicle body 12 or the moldings 13 is caused to emit and display light to show operation announcement information that indicates that the host vehicle 15 will stop in front of the intersection and prompts the pedestrian 70 to cross the pedestrian crossing first to the pedestrian as traffic information.

When traffic information is generated by the analysis unit 22 and provision target content is generated by the provision target content generating unit 23 as described above, the vehicle side communication ECU 20 causes the vehicle body 12 or the moldings 13 to emit and display light such that the light can be visually recognized by a person in the vicinity of the host vehicle 15 and can be received by the information acquiring and providing device 30. Specifically, the vehicle side communication ECU 20 causes the light emitting devices 11 of the vehicle body 12 or the moldings 13 to flicker at a frequency equal to or higher than a predetermined frequency.

Note that, the predetermined frequency is the lowest frequency at which a person can visually recognize light as if the light emitting devices 11 are emitting light continuously (that is, as if light emitting devices 11 are not flickering) and a data signal indicating the traffic information described above can be received through optical wireless communication and is, for example, 60 Hz. A data signal transmitted through the flickering of the light emitting devices 11 is modulated by means of a predetermined modulation method (for example, AM modulation, FM modulation, pulse width modulation, pulse code modulation, or like) with traffic information superimposed on a carrier wave.

In addition, the contents of traffic information that is visually recognized by means of light emitted from the light emitting devices 11 and the contents of traffic information that is transmitted through optical wireless communication by means of high speed flickering of the light emitting devices 11 may be the same information items as each other and may be information items different from each other. Furthermore, when the contents of both of the traffic information items are different from each other, the traffic information that is transmitted through the optical wireless communication by means of the high-speed flickering may be detailed information more specifically indicating the contents of the traffic information to be visually recognized. For example, when the contents of the traffic information to be visually recognized is “VEHICLE WILL STOP.”, the contents of the traffic information that is transmitted through the optical wireless communication by means of the high-speed flickering may be “VEHICLE WILL STOP. PLEASE CROSS PEDESTRIAN CROSSING FIRST.” or the like.

For example, when the host vehicle 15 is in an autonomously driven state, the vehicle side communication ECU 20 causes the light emitting devices 11 to emit light such that visible bluish white light corresponding to the autonomously driven state is displayed and emitted by the vehicle body 12 or the moldings 13, the visible bluish white light can be visually recognized, and a signal indicating the autonomously driven state and transmitted by means of high-speed flickering is received by the information acquiring and providing device 30 of another person through optical wireless communication. When the host vehicle 15 is not in an autonomously driven state although the host vehicle 15 is an autonomous vehicle, the light emitting devices 11 are caused to emit light such that visible orange light corresponding to a non-autonomously driven state is displayed and emitted by the vehicle body 12 or the moldings 13, the visible orange light can be visually recognized, and a signal indicating the non-autonomously driven state and transmitted by means of high-speed flickering is received by the information acquiring and providing device 30 of the other person through optical wireless communication.

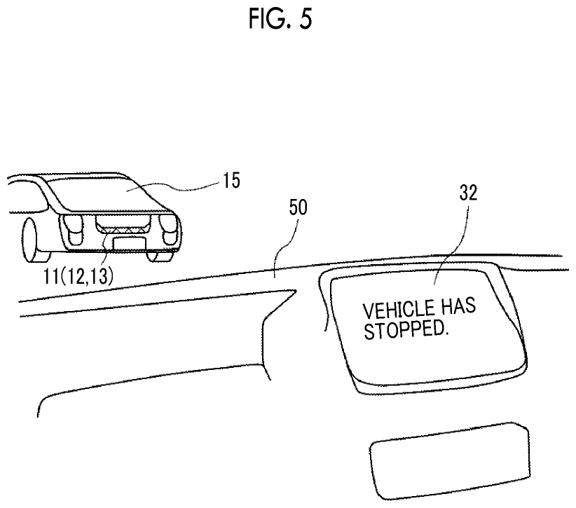

In addition, for example, when operation information indicating that the host vehicle 15 has stopped in front of an intersection where a pedestrian or the like is present is to be shown to the following non-host vehicle 50, the vehicle side communication ECU 20 causes the light emitting devices 11 to emit light such that a text like “VEHICLE HAS STOPPED.” corresponding to the operation information is displayed by the vehicle body 12 or the moldings 13 as shown in FIG. 5, the text can be visually recognized, and a signal indicating the operation information and transmitted by means of high-speed flickering is received by the information acquiring and providing device 30 of the following non-host vehicle 50 through optical wireless communication. When the following non-host vehicle is to be notified of congestion information, the light emitting devices 11 are caused to emit light such that a text like “THERE IS CONGESTION.” corresponding to the congestion information is displayed by the vehicle body 12 or the moldings 13, the text can be visually recognized, and a signal indicating the congestion information and transmitted by means of high-speed flickering is received by the information acquiring and providing device 30 of the following non-host vehicle through optical wireless communication. When operation announcement information indicating that the host vehicle 15 will stop in front of an intersection is to be shown to the pedestrian 70, the light emitting devices 11 are caused to emit light such that a text like “VEHICLE WILL STOP.” corresponding to the operation announcement information is displayed by the vehicle body 12 or the moldings 13 as shown in FIG. 7, the text can be visually recognized, and a signal that indicates the operation announcement information and is transmitted by means of high-speed flickering is received by the information acquiring and providing device 30 of the pedestrian 70 through the optical wireless communication.

As shown in FIG. 1, the information acquiring and providing device 30 includes a light receiving device 31. The light receiving device 31 is a receiver that can receive light emitted from the light emitting devices 11 of the host vehicle 15. The light receiving device 31 mainly receives visible light. The light receiving device 31 is a camera or a photoelectric conversion element, for example. When the information acquiring and providing device 30 is installed in a vehicle, the light receiving device 31 is disposed at each of a front portion, a rear portion, a side portion, and the like of the vehicle.

The information acquiring and providing device 30 includes a communication electronic control unit (hereinafter, will be referred to as provider side communication ECU) 40 that is composed of a microcomputer serving as a main component. The provider side communication ECU 40 is electrically connected to the light receiving device 31. The provider side communication ECU 40 is a controller that communicates with the host vehicle 15 (specifically, vehicle-mounted light emitting device 10) through wireless communication based on light received by the light receiving device 31. The provider side communication ECU 40 includes a signal separation unit 41, an analysis unit 42, and a provision target content generating unit 43.

The signal separation unit 41 is a unit that performs a demodulation process of separating a carrier wave from a signal transmitted by means of light received by the light receiving device 31 and extracting information. The analysis unit 42 detects the information extracted by the signal separation unit 41 as traffic information that is transmitted from the host vehicle 15 through optical wireless communication and is generated in the vicinity of the information acquiring and providing device 30. Note that, a relationship between information extracted by the signal separation unit 41 and traffic information may be stored in a predetermined storage unit in the information acquiring and providing device 30 in advance. The provision target content generating unit 43 is a unit that generates contents to be provided to a person using the information acquiring and providing device 30 based on traffic information detected and analyzed by the analysis unit 42. Note that, a relationship between traffic information detected by the analysis unit 42 and provision target content may be stored in a predetermined storage unit in advance.

The information acquiring and providing device 30 includes a displaying/voice outputting unit 32. The displaying/voice outputting unit 32 is a provider such as a warning lamp, a monitor of a navigation device that displays a text and an image, a head-up display, a speaker or an earphone that outputs a voice or a sound, a vibration member (for example, vehicle sheet or steering wheel) that vibrates, and the like. The displaying/voice outputting unit 32 displays provision target content generated by the provision target content generating unit 43 or outputs the provision target content through both or one of a sound and vibration. When traffic information is generated by the analysis unit 42 and provision target content is generated by the provision target content generating unit 43 as described above, the provider side communication ECU 40 causes the displaying/voice outputting unit 32 to output the provision target content, which is the traffic information, visually, aurally, and/or tactually.

In a case where operation information indicating that the host vehicle 15 as a preceding vehicle has stopped is received as traffic information by the light receiving device 31 of the non-host vehicle 50 following the host vehicle 15, the displaying/voice outputting unit 32 displays a text like “VEHICLE HAS STOPPED.” as shown in FIG. 5 such that the text can be visually recognized. In addition, in a case where operation announcement information indicating that the host vehicle 15 will stop in front of an intersection is received as traffic information by the light receiving device 31 of a portable device 80 carried by the pedestrian 70 in the vicinity of the host vehicle 15 as shown in FIG. 6, a text like “VEHICLE WILL STOP. PLEASE CROSS PEDESTRIAN CROSSING FIRST.” is displayed as shown in FIG. 7 such that the text can be visually recognized.

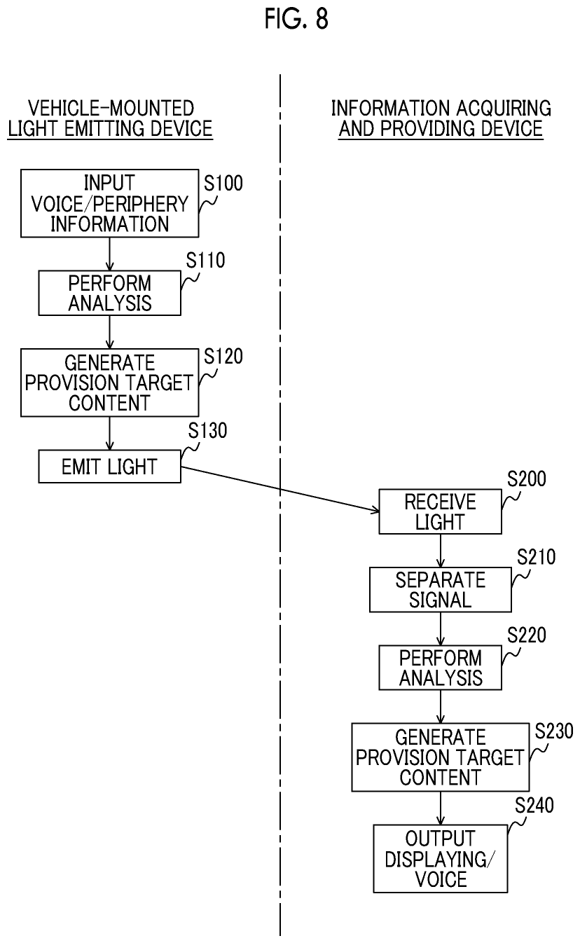

Next, the operation of the vehicle communication system 1 will be described. When a voice or information about the vicinity of the host vehicle 15 is input through the voice/surrounding information input unit 21 of the vehicle side communication ECU 20 in the vehicle-mounted light emitting device 10 of the host vehicle 15 (step S100 shown in FIG. 8), traffic information such as operation announcement information, operation information, intersection information, risk information, and congestion information is detected by the analysis unit 22 (step S110), and provision target content is generated by the provision target content generating unit 23 (step S120), light is emitted and displayed by any of the vehicle body 12 and the moldings 13 of the host vehicle 15 in a state indicating the traffic information (step S130). This light emitting and displaying operation is a signage displaying operation that is performed in accordance with the traffic information and can be visually recognized by a person in the vicinity of the host vehicle 15 and is a high-speed flickering displaying operation that can be received by the information acquiring and providing device 30 of another person through optical wireless communication.

When the light is emitted and displayed by the vehicle body 12 or the moldings 13 of the host vehicle 15 in a state indicating the traffic information as described above, a person in the vicinity of the host vehicle 15 can recognize the traffic information by visually recognizing the light emitted and displayed on the vehicle body 12 or the moldings 13. In addition, in the case of the information acquiring and providing device 30, when the light emitted and displayed by the vehicle body 12 or the moldings 13 of the host vehicle 15 is received (step S200), a carrier wave is separated from a signal transmitted through the light by the signal separation unit 41 (step S210), the traffic information is detected by the analysis unit 42 (step S220), provision target content is generated by the provision target content generating unit 43 (step S230), and the traffic information is visually, aurally, and/or tactually output from the displaying/voice outputting unit 32 (step S240). In this case, a person using the information acquiring and providing device 30 can recognize the traffic information through the output.

As described above, in the vehicle communication system 1, with at least one of the vehicle body 12 and the moldings 13 flickering at a high speed in accordance with traffic information input to the vehicle-mounted light emitting device 10 of the host vehicle 15, the traffic information is transmitted to a person in the vicinity of the host vehicle 15 such that the traffic information can be visually recognized directly, the traffic information is transmitted to the information acquiring and providing device 30 in the vicinity of the host vehicle 15 through optical wireless communication, and the traffic information is transmitted visually, aurally, and/or tactually to a user of the information acquiring and providing device 30. In this case, the person (specifically, occupant of non-host vehicle or two-wheeled vehicle other than host vehicle 15, occupant of bicycle, or pedestrian) in the vicinity of the host vehicle 15 can be aware of the traffic information input to the vehicle-mounted light emitting device 10 of the host vehicle 15 by seeing the vehicle body 12 or the moldings 13 of the host vehicle 15. In addition, the user of the information acquiring and providing device 30 can be aware of the traffic information input to the vehicle-mounted light emitting device 10 of the host vehicle 15 by seeing, hearing, and/or feeling the output of the displaying/voice outputting unit 32.

Therefore, with the vehicle communication system 1, it is possible to easily and reliably transmit traffic information to another person from the vehicle-mounted light emitting device 10 of the host vehicle 15. In addition, it is sufficient to cause the light emitting devices 11 of the vehicle body 12 or the moldings 13 of the host vehicle 15 to flicker at a high speed when transmitting traffic information to a person in the vicinity of the host vehicle 15 such that the traffic information can be visually recognized directly and transmitting the traffic information to the information acquiring and providing device 30 in the vicinity of the host vehicle 15 through optical wireless communication. Therefore, each of a dedicated light emitting device used for direct visual recognition and a dedicated light emitting device used for optical wireless communication does not need to be provided separately. Accordingly, it is possible to simplify the system and achieve a decrease in number of components and thus it is possible to realize transmission of traffic information to another person from the vehicle-mounted light emitting device 10 of the host vehicle 15 with a simple configuration.

For example, in a case where the host vehicle 15 with the vehicle body 12 or the moldings 13 emitting and displaying light is stopped at an intersection or the like, a user (pedestrian 70 in many cases) of the portable device 80 in which the information acquiring and providing device 30 is installed can cause traffic information output from the vehicle body 12 or the moldings 13 of the host vehicle 15 to be visually, aurally, and/or tactually output from the displaying/voice outputting unit 32 of the information acquiring and providing device 30 by aiming the light receiving device (specifically, camera) 31 of the portable device 80 at the host vehicle 15 as shown in FIG. 7. Therefore, the user of the information acquiring and providing device 30 can recognize the traffic information by directly seeing light emitted and displayed by the vehicle body 12 or the moldings 13 of the host vehicle 15 and can recognize the traffic information by seeing the displaying/voice outputting unit 32 of the information acquiring and providing device 30. Accordingly, it is possible to realize transmission of traffic information to a user of the information acquiring and providing device 30 from the vehicle-mounted light emitting device 10 of the host vehicle 15 in two ways and thus it is possible to more reliably provide traffic information to the user or to provide more detailed or wide-ranging traffic information the user.

In addition, when a person in the vicinity of the host vehicle 15 cannot see the vehicle body 12 or the moldings 13 of the host vehicle 15, the person cannot directly recognize traffic information input to the vehicle-mounted light emitting device 10 of the host vehicle 15. In addition, when the information acquiring and providing device 30 cannot receive light emitted and displayed by the vehicle body 12 or the moldings 13 of the host vehicle 15, traffic information input to the vehicle-mounted light emitting device 10 of the host vehicle 15 cannot be provided to a user of the information acquiring and providing device 30 and thus the user cannot recognize the traffic information through the displaying/voice outputting unit 32. Therefore, a time at which transmission of information from the vehicle-mounted light emitting device 10 of the host vehicle 15 to another person can be realized is limited to a time at which visibility between the host vehicle 15 and the other person is good and thus it is easily secure a high security level for transmission of the information.

Meanwhile, in the above-described embodiment, the host vehicle 15 and the light emitting devices 11 of the vehicle-mounted light emitting device 10 include light sources that generate visible light. However, the disclosure is not limited thereto and the light emitting device 11 of the host vehicle 15 may include a light source that generates invisible light (for example, near infrared light or infrared light) in addition to a light source that generates visible light. In the case of a structure in a modification embodiment as described above, the light source for generation of visible light and the light source for generation of invisible light of the light emitting device 11 may be disposed together in a region in which the light source for generation of visible light is disposed. In addition, traffic information transmitted by means of high-speed flickering of the light source for generation of visible light and traffic information transmitted by means of high-speed flickering of the light source for generation of invisible light may be the same as each other and may be different from each other. In addition, in the modification embodiment, the light receiving device 31 of the information acquiring and providing device 30 is a device that can receive both of visible light and invisible light emitted by the light emitting devices 11.

In addition, in the above-described embodiment, the vehicle communication system 1 is a system provided with the vehicle-mounted light emitting device 10 and the information acquiring and providing device 30. However, the host vehicle 15 may be a vehicle in which the vehicle-mounted light emitting device 10 is installed the information acquiring and providing device 30 is also installed and the vehicle communication system 1 can be realized when the host vehicle 15 comes into wide use.

Note that, the disclosure is not limited to the above-described embodiment or the modification embodiment and various modifications can be made without departing from the spirit of the disclosure.

What is claimed is:

1. A vehicle communication system comprising:
a vehicle-mounted light emitting device including a vehicle body or a molding, and a light emission controller, the vehicle body or the molding being configured to emit visible light, the molding being attached to the vehicle body, and the light emission controller being configured to cause the vehicle body or the molding to flicker at a frequency equal to or higher than a predetermined frequency such that traffic information is visually recognized by a person in a vicinity of a host vehicle and is transmitted to the vicinity of the host vehicle through optical wireless communication; and
an information acquiring and providing device including a receiver and a provider, the receiver being configured to receive the traffic information transmitted from the vehicle body or the molding through the optical wireless communication and the provider being configured to provide the traffic information received by the receiver to a person who uses the information acquiring and providing device.

2. The vehicle communication system according to claim 1, wherein the information acquiring and providing device is installed in a vehicle or is installed in a portable device carried by a person.

3. The vehicle communication system according to claim 1, wherein the vehicle body is a body of an autonomous vehicle that is autonomously drivable.

4. The vehicle communication system according to claim 1, wherein the traffic information includes any of congestion information, intersection information, pedestrian information, risk information, and operation information of the host vehicle.

5. The vehicle communication system according to claim 1, wherein contents of the traffic information to be visually recognized by the person in the vicinity of the host vehicle and contents of the traffic information to be transmitted to the vicinity of the host vehicle through the optical wireless communication in the vehicle-mounted light emitting device are different from each other.

6. The vehicle communication system according to claim 1, wherein:
the vehicle body or the molding includes a first light source that emits visible light and a second light source that emits invisible light; and
the transmission of the traffic information through the optical wireless communication is performed by means of both of the first light source and the second light source.

7. A vehicle-mounted light emitting device applied to a vehicle communication system, the vehicle-mounted light emitting device comprising:
a vehicle body or a molding configured to emit visible light, the molding being attached to the vehicle body; and
a light emission controller configured to cause the vehicle body or the molding to flicker at a frequency equal to or higher than a predetermined frequency such that traffic information is visually recognized by a person in a vicinity of a host vehicle and is transmitted to the vicinity of the host vehicle through optical wireless communication.

8. An information acquiring and providing device applied to a vehicle communication system, the vehicle communication system including a vehicle-mounted light emitting device including a vehicle body or a molding, and a light emission controller, the vehicle body or the molding being configured to emit visible light, the light emission controller being configured to cause the vehicle body or the molding to flicker at a frequency equal to or higher than a predetermined frequency such that traffic information is visually recognized by a person in a vicinity of a host vehicle and is transmitted to the vicinity of the host vehicle through optical wireless communication, the information acquiring and providing device comprising:
a receiver configured to receive the traffic information transmitted from the vehicle body or the molding through the optical wireless communication; and
a provider configured to provide the traffic information received by the receiver to a person who uses the information acquiring and providing device.

9. A vehicle-mounted device comprising:
a vehicle body or a molding configured to emit visible light, the molding being attached to the vehicle body;
a light emission controller configured to cause the vehicle body or the molding to flicker at a frequency equal to or higher than a predetermined frequency such that traffic information is visually recognized by a person in a vicinity of a host vehicle and is transmitted to the vicinity of the host vehicle through optical wireless communication;
a receiver configured to receive the traffic information transmitted from a vehicle body or a molding of a non-host vehicle through the optical wireless communication; and
a provider configured to provide the traffic information received by the receiver to an occupant of the host vehicle.
